(19) United States
(12) Patent Application Publication
(10) Pub. No.: US 2017/0137667 A1
(43) Pub. Date: May 18, 2017

(54) VARNISH FOR PHOTO ALIGNMENT FILM AND LIQUID CRYSTAL DISPLAY DEVICE

(71) Applicant: Japan Display Inc., Minato-ku (JP)

(72) Inventors: Hidehiro SONODA, Tokyo (JP); Yasushi TOMIOKA, Tokyo (JP); Noboru KUNIMATSU, Tokyo (JP); Takenori HIROTA, Tokyo (JP)

(73) Assignee: Japan Display Inc., Minato-ku (JP)

(21) Appl. No.: 15/347,067

(22) Filed: Nov. 9, 2016

(30) Foreign Application Priority Data
Nov. 13, 2015 (JP) 2015-223360

(51) Int. Cl. C09D 179/08; G02F 1/1337

(52) U.S. Cl. CPC C09D 179/08; G02F 1/133723; G02F 1/133788; G02F 2001/133397

(57) ABSTRACT

According to one embodiment, a varnish for a photo alignment film includes a first polyamic acid-based compound, which is a polyamic acid or a polyamic acid ester, in an organic solvent. The first polyamic acid-based compound has terminal skeletons containing no primary amino group.

### CROSS-REFERENCE TO RELATED APPLICATIONS

This application is based upon and claims the benefit of priority from Japanese Patent Application No. 2015-223360, filed Nov. 13, 2015, the entire contents of which are incorporated herein by reference.

### FIELD

Embodiments described herein relate generally to a varnish for a photo alignment film and a liquid crystal display device.

### BACKGROUND

A liquid crystal display device comprises an array substrate provided with, for example, pixel electrodes and thin-film transistors (TFTs) arranged in a matrix and an opposite substrate arranged opposite to the array substrate and provided with, for example, color filters. A liquid crystal is sealed between the array substrate and the opposite substrate.

The liquid crystal is aligned by liquid crystal alignment films which are disposed on the array substrate and the opposite substrate, respectively. Polyimide films are frequently used as the alignment films. Recently, a photo-alignment technique, which can impart the alignment control capability to polyimide films in a non-contact manner, has been adopted, in addition to rubbing treatment.

The photo-alignment technique comprises irradiating the polyimide film with ultraviolet (UV) light having a short wavelength of 254 to 365 nm to achieve the alignment. In the polyimide film irradiated with the polarized light, some main chains of the polyimide molecules are cut in a direction parallel to the direction of polarization, and the polyimide film is given uniaxial anisotropy in a direction perpendicular to the direction of polarization. Liquid crystal molecules are aligned along the remaining main chains of the polyimide molecules which have not been cut, and thus are kept long and linearly extend.

### BRIEF DESCRIPTION OF THE DRAWINGS

FIG. 1 is a schematic cross-sectional view partially illustrating a display panel of a liquid crystal display device according to one embodiment.

FIG. 2 is a plan view partially illustrating a pixel electrode in the liquid crystal display device illustrated in FIG. 1.

FIG. 3 is a perspective view illustrating a construction of an alignment film having a two-layer structure according to one embodiment.

FIG. 4 is a view illustrating a pattern for inspection of a DC afterimage.

### DETAILED DESCRIPTION

The present inventors have confirmed that when a liquid crystal display device incorporating a polyimide alignment film having been subjected to photo-alignment processing (photo alignment polyimide film) is turned on and an image is displayed, the photo alignment polyimide film becomes excited by the light emitted from the backlight as the lighting time of the backlight proceeds, producing a photoelectromotive force, as a result of which charge is accumulated in the photo alignment polyimide film, leading to an afterimage (DC afterimage).

In recent years, alignment films have been required to have a higher resistance in order to improve a voltage holding ratio of a pixel electrode. However, the present inventors have found that only in the case where a photo-alignment processing has been conducted on a polyimide film, which has a high resistance, when a liquid crystal display device is continuously turned on, the photo-charge of the alignment film is produced in the liquid crystal cells, and an afterimage does not disappear even when the application of a voltage to the pixel electrodes is stopped. As a result of the present inventors' investigation, it has been confirmed that before and after the photo-alignment processing, in which short-wavelength UV irradiation is used, an absorption wavelength of the polyimide film changes. More specifically, as a result of the photo-alignment processing noted above, the photo alignment film came to slightly absorb UV light emitted of 450 nm or less within the emission wavelength of the backlight. The present inventors investigated its cause in detail, and found that the cause is the primary amines present at the terminals of the chemical structure of the polyimide. It is inferred that the primary amines are displaced in the photo-alignment process, leading to the change of the absorption wavelength of the polyimide film.

Furthermore, the inventors have made extensive studies on the DC afterimage caused by the polyimide film. They have found that by making the polyimide to have groups other than primary amino groups at its both terminals, the DC afterimage can be prevented from occurring, or even if a DC image occurs, it can be disappeared within a short period of time. Making the polyimide to have groups other than primary amino groups at its both terminals can be achieved making a polyamic acid or a polyamic acid ester (usually provided in the form of varnish), which is a precursor of the polyimide, to have groups other than primary amino groups at its both terminals. When such polyamic acid or polyamic acid ester is imidized, a polyimide having, at its both terminals, groups other than primary amino groups is produced.

Thus, a varnish for producing a photo alignment film according to one embodiment comprises a first polyamic acid-based compound, which is a polyamic acid or a polyamic acid ester, in an organic solvent. The first polyamic acid-based compound has terminal skeletons containing no primary amino group. The terminal skeleton comprises, for example, an imide skeleton, an amide skeleton, a urea skeleton, a tertiary amino skeleton, an azo bond, or carboxyl group.

In some embodiments, the first polyamic acid-based compound has a structural unit (repeating unit) represented by Formula (1) below:

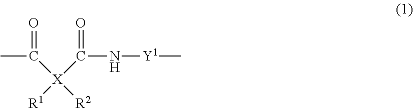

where X is a cyclic group, each of R¹ and R² is independently —COOH or —COOR where R is an alkyl group, and Y¹ is an organic group, and its terminal skeletons each comprise an imide skeleton, an amide skeleton, a urea skeleton, a tertiary amino skeleton, an azo bond or a carboxyl group.

In one embodiment, X is an alicyclic group, for example, a substituted or unsubstituted cyclobutane group. In another embodiment, X is a benzene ring or a benzene ring-containing group, wherein the benzene ring may be substituted with an alkyl group or the like. Preferably, X is the alicyclic group.

In some embodiments, both terminal skeletons of the first polyamic acid-based compound are represented by

Formula (2):

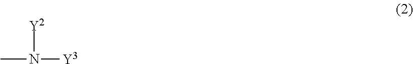

where Y² is H, S or an organic group, and Y³ is an aliphatic group or an aromatic group; or Y² and Y³ are bonded together to form a cyclic group, for example, imide;

Formula (3) below:

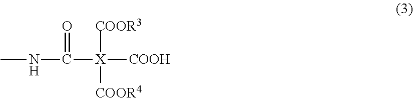

where Y⁴ is an organic group; or

Formula (4) below:

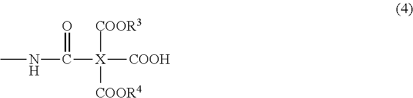

where X is as defined above, and each of R³ and R⁴ is independently hydrogen or an alkyl group.

In some embodiments, the first polyamic acid-based compound has an amine skeleton represented by Formula (5) below:

—HN-L-NH— (5)

where L is an organic group, for example, a cyclic group-containing group. In some embodiments, L is Ar⁰ or Ar¹—Z—Ar², where Ar⁰ is an aromatic group, each of Ar¹ and Ar² is independently an aromatic group, and Z is an organic group containing no primary amino group and no secondary amino group. An example of the aromatic group represented by Ar⁰, Ar¹ or Ar² is a benzene ring or a benzene ring-containing group. Alternatively, Z is constituted by oxygen, nitrogen, sulfur, carbon or hydrogen, or a combination of two or more of them. Z contains no hydroxyl group, no thiol group and no amino group other than tertiary amino group, i.e., no —NH nor >NH.

The polyamic acid can be produced by reacting a tetracarboxylic acid dianhydride with a diamine by an ordinary method.

The tetracarboxylic acid dianhydride can be represented by Formula (A) below:

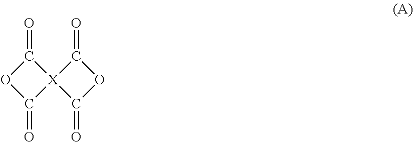

where X is a cyclic group as defined above with respect to Formula (1) above.

The tetracarboxylic acid dianhydride having a substituted or unsubstituted cyclobutane group as X can be represented by Formula (B) below:

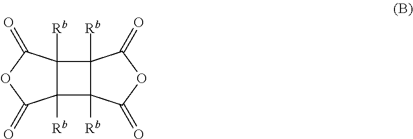

where each R^{b} is independently hydrogen or an alkyl group. An example of the alkyl group is an alkyl group having one to six carbon atoms. Particularly preferably, the alkyl group is methyl group.

An example of the tetracarboxylic acid dianhydride having a benzene ring as X is pyromellitic acid.

Preferably, the tetracarboxylic acid dianhydride is the one represented by Formula (B) above.

The diamine to be reacted with the above tetracarboxylic acid dianhydride is an organic compound having two primary amino groups. The diamine can be represented by Formula (C):

H₂N-L-NH₂ (C)

where L is as defined with respect to Formula (5) above.

The diamine represented by Formula (C) includes an alicyclic diamine, a heterocyclic diamine, an aliphatic diamine and an aromatic diamine.

Examples of the alicyclic diamine are 1,3-diaminocyclohexane, 1,4-diaminocyclohexane, 4,4′-diaminodicyclohexylmethane, 4,4′-diamino-3,3′-dimethyldicyclohexylamine, isophoronediamine, etc.

Examples of the heterocyclic diamine are 2,6-diaminopyridine, 2,4-diaminopyridine, 2,4-diamino-1,3,5-triazine, 2,7-diaminodibenzofuran, 3,6-diaminocarbazole, 2,4-diamino-6-isopropyl-1,3,5-triazine, 2,5-bis(4-aminophenyl)-1,3,4-oxadiazole, etc.

Examples of the aliphatic diamine are 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,3-diamino-2,2-dimethylpropane, 1,6-diamino-2,5-dimethylhexane, 1,7-diamino-2,5-dimethylheptane, 1,7-diamino-4,4-dimethylheptane, 1,7-diamino-3-methylheptane, 1,9-diamino-5-methylheptane, 1,12-diaminododecane, 1,18-diaminooctadecane, 1,2-bis(3-aminopropoxy)ethane, etc.

Examples of the aromatic diamine are o-phenylenediamine, m-phenylenediamine, p-phenylenediamine, 2,4-diaminotoluene, 2,5-diaminotoluene, 3,5-diaminotoluene, 1,4-diamino-2-methoxybenzene, 2,5-diamino-p-xylene, 1,3-diamino-4-chlorobenzene, 3,5-diaminobenzoic acid, 1,4-diamino-2,5-dichlorobenzene, 4,4′-diamino-1,2-diphenylethane, 4,4′-diamino-2,2′-dimethylbibenzyl, 4,4′-diaminodiphenylmethane, 3,3′-diaminodiphenylmethane, 3,4′-diaminodiphenylmethane, 4,4′-diamino-3,3′-dimethyldiphenylmethane, 2,2′-diaminostillbene, 4,4′-diaminostillbene, 4,4′-diaminodiphenyl ether, 3,4′-diaminodiphenyl ether, 4,4′-diaminodiphenyl sulfide, 4,4′-diaminodiphenyl sulfone, 3,3′-diaminodiphenyl sulfone, 4,4′-diaminobenzophenone, 1,3-bis(3-aminophenoxy)benzene, 1,3-bis(4-aminophenoxy)benzene, 1,4-bis(4-aminophenoxy)benzene, 3,5-bis(4-aminophenoxy)benzoic acid, 4,4′-bis(4-aminophenoxy)bibenzyl, 2,2-bis[(4-aminophenoxy)methyl]propane, 2,2-bis[4-(4-aminophenoxy)phenyl]hexafluoropropane, 2,2-bis[4-(4-aminophenoxy)phenyl]propane, bis[4-(3-aminophenoxy)phenyl] sulfone, bis[4-(4-aminophenoxy)phenyl] sulfone, 1,1-bis(4-aminophenyl)cyclohexane, α,α′-bis(4-aminophenyl)-1,4-diisopropylbenzene, 9,9-bis(4-aminophenyl)fluorene, 2,2-bis(3-aminophenyl)hexafluoropropane, 2,2-bis(4-aminophenyl)hexafluoropropane, 4,4′-diaminodiphenylamine, 2,4-diaminodiphenylamine, 1,8-diaminonaphthalene, 1,5-diaminonaphthalene, 1,5-diaminoanthraquinone, 1,3-diaminopyrene, 1,6-diaminopyrene, 1,8-diaminopyrene, 2,7-diaminofluorene, 1,3-bis(4-aminophenyl)tetramethyldisiloxane, benzidine, 2,2′-dimethylbenzidine, 1,2-bis(4-aminophenyl)ethane, 1,3-bis(4-aminophenyl)propane, 1,4-bis(4-aminophenyl)butane, 1,5-bis(4-aminophenyl)pentane, 1,6-bis(4-aminophenyl)hexane, 1,7-bis(4-aminophenyl)heptane, 1,8-bis(4-aminophenyl)octane, 1,9-bis(4-aminophenyl)nonane, 1,10-bis(4-aminophenyl)decane, 1,3-bis(4-aminophenoxy)propane, 1,4-bis(4-aminophenoxy)butane, 1,5-bis(4-aminophenoxy)pentane, 1,6-bis(4-aminophenoxy)hexane, 1,7-bis(4-aminophenoxy)heptane, 1,8-bis(4-aminophenoxy)octane, 1,9-bis(4-aminophenoxy)nonane, 1,10-bis(4-aminophenoxy)decane, di(4-aminophenyl)propane-1,3-dioate, di(4-aminophenyl)butane-1,4-dioate, di(4-aminophenyl)pentane-1,5-dioate, di(4-aminophenyl)hexane-1,6-dioate, di(4-aminophenyl)heptane-1,7-dioate, di(4-aminophenyl)octane-1,8-dioate, di(4-aminophenyl)nonane-1,9-dioate, di(4-aminophenyl)decane-1,9-dioate, 1,3-bis[4-(4-aminophenoxy)phenoxy]propane, 1,4-bis[4-(4-aminophenoxy)phenoxy]butane, 1,5-bis[4-(4-aminophenoxy)phenoxy]pentane, 1,6-bis[4-(4-aminophenoxy)phenoxy]hexane, 1,7-bis[4-(4-aminophenoxy)phenoxy]heptane, 1,8-bis[4-(4-aminophenoxy)phenoxy]octane, 1,9-bis[4-(4-aminophenoxy)phenoxy]nonane, 1,10-bis[4-(4-aminophenoxy)phenoxy]decane, etc. Further examples of the aromatic diamine are listed below (in the further examples below, n denotes an integer of 1 to 10):

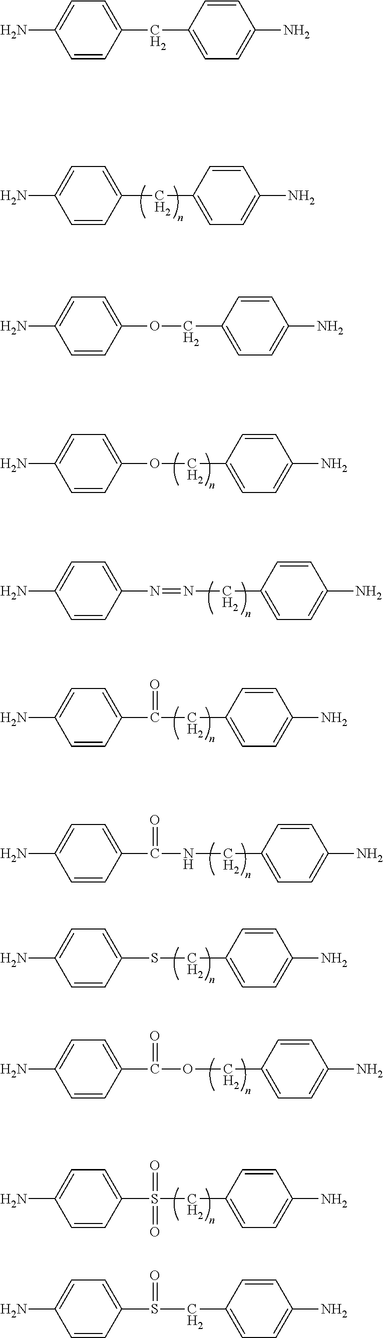

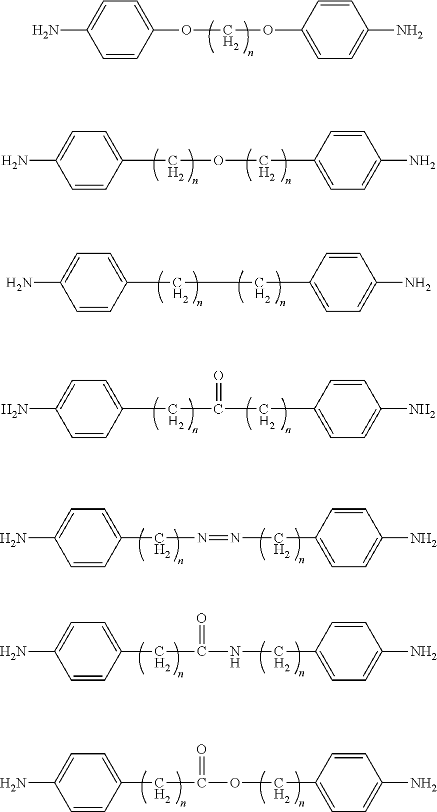

The aromatic diamine can be represented by Formula (D) or (E) below:

H₂N—Ar⁰—NH₂ (D)

H₂N—Ar¹—Z—Ar²—NH₂ (E)

where Ar⁰, Ar¹, Ar² and Z are as defined with respect to Formula (5) above. An alignment film formed using the amine represented by Formula (D) has a high photo-alignability, and is preferably used to produce a second polyamic acid-based compound described below. An alignment film formed using the amine represented by Formula (E) does not contain thiol group or hydroxyl group, and thus is not greatly influenced by a hydrogen bond. Accordingly, its resistance tends to become high. Also, this diamine does not contain an amino group other than a tertiary amine in Z, i.e., does not contain —NH or >NH in Z, and DC afterimages can be prevented from generating. Accordingly, it is preferable that the diamine of Formula (E) be used to produce the first polyamic acid-based compound. It should be noted that an amide bond is distinguished from a secondary amino group, since their chemical properties are different from each other. That is, an amine containing an amide bond in Z is not excluded, i.e., can be used.

In the reaction of the tetracarboxylic acid dianhydride and the diamine, when the diamine is used in an amount slightly larger than the amount of the tetracarboxylic acid dianhydride (for example, in a molar amount 1.1 to 1.5 times larger than the molar amount of the tetracarboxylic acid dianhydride), a polyamic acid having primary amino groups at its both terminals, or a polyamic acid having primary amines as the terminal skeletons, is produced.

A polyamic acid ester can be produced by reacting, for example, N,N-dimethylformamide dialkyl acetal with the polyamic acid described above. Alternatively, a polyamic acid ester can also be produced by the method disclosed in JP 2000-273172 A.

The first polyamic acid-based compound noted above can be obtained by chemically modifying the terminal primary amino groups of the polyamic acid or the polyamic acid ester, which has the primary amino groups at its both terminals. This chemical modification is a capping of the primary amino groups.

A method for chemically modifying a terminal primary amino group includes amidation. As a capping agent (amidating agent) used for this purpose, a compound having one halogenated carbonyl group in the molecule, i.e. a monofunctional acid halide, can be used. The halide includes chloride, bromide and fluoride. Examples of the monofunctional acid halide include benzoyl chloride, acetyl chloride, propionyl chloride, acryloyl chloride, methacryloyl chloride and tosyl chloride.

Furthermore, as another capping agent which achieves the amidation, a compound having one acid anhydride, i.e., a monofunctional acid anhydride, may be used. Examples of the monofunctional acid anhydride are phthalic anhydride, maleic anhydride, succinic anhydride, itaconic anhydride, trimellitic anhydride, 1,2,4-cyclohexanetricarboxylic acid-1,2-anhydrid, cyclohexene-1,2-dicarboxylic anhydride, etc. In the case where the terminal primary groups are chemically modified with these compounds, ordinarily, the terminals are converted into polyamic acids. Thereafter, the resulting compound is formed into a film, and baked to be imidized.

Furthermore, for amidation, esterification into amic acid esters may be used. To convert the terminals into amic acid esters, it suffices that an amino-reactive group such as carboxyl group or an acid halide (halogenated carbonyl group) and a known aromatic compound having an ester skeleton are used as capping agents. Also, the conversion of the terminals into amic acid esters can be effected by reacting the compound having its terminals converted into amic acid by the above method with, for example, N, N-dimethylformamide dialkyl acetal. In the case where the terminal primary amino groups are chemically modified with these compounds, ordinarily, the terminals become polyamic acid esters. Thereafter, the resulting compound is formed into a film, and baked to be imidized.

Also, the terminals may be in imidized state. In order to obtain the imidized terminals, it suffices that the above capped compound having the terminals converted into polyamic acid or polyamic acid ester is heated to be dehydration-condensed.

It should be noted that a chemical modification other than amidation and imidization may be applied, for example, azotization, ureation or tertiary amination may be applied.

For azotization, a diazonium salt-based diazo coupling agent can be used as a capping agent (azotization agent). For ureation, an isocyanate-based compound can be used as a capping agent. Examples of the isocyanate are phenyl isocyanate, naphthyl isocyanate, etc. For tertiary amination, a compound having a halogen group (especially, chlorine) or hydroxyl group can be used as a capping agent (tertiary amination agent). It should be noted that substances other than the above capping agents can be used for the azotization, ureation or tertiary amination.

In another embodiment, a polyamic acid-based compound having terminal skeletons not containing a primary amino group can be produced by using, in the reaction of the tetracarboxylic acid dianhydride and the diamine note above, the tetracarboxylic acid dianhydride in an amount larger than the amount of the diamine (for example, in a molar amount 1.1 to 1.5 times larger than the amount of the diamine). This reaction produces a polyamic acid having carboxyl groups at its terminals. In the case where the varnish contains one or more polyamic acid-based compounds each having carboxyl groups at the both terminals and one or more other polyamic acid-based compounds, it is preferable that the total amount of the polyamic acid-based compounds each having carboxyl groups at the both terminals occupy 80% by mass or more, more preferably 90% by mass or more of the sum of the total amount of the polyamic acid-based compounds each having carboxyl groups at the both terminals and the total amount of the other polyamic acid-based compounds.

As is clear from the above explanation, the first polyamic acid-based compound having groups other than primary amino groups at its both terminals can have an acid skeleton represented by Formula (6) below:

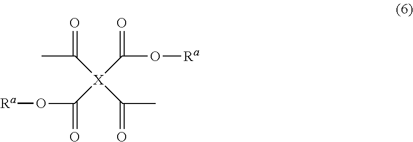

where X is as described above with respect to Formula (1) above.

The acid skeleton represented by the formula (6) includes acid skeletons represented by Formulas (6-1) and (6-2) below:

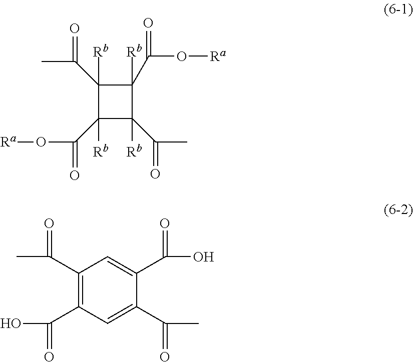

In Formula (6-1), R^{a} is an alkyl group, for example, an alkyl group having 1 to 6 carbon atoms, and R^{b} is hydrogen or an alkyl group as defined with respect to Formula (B) above.

The amine skeleton is as described above.

Furthermore, as is clear from the above, the first polyamic acid-based compound can have the structural unit (repeating unit) represented by Formula (1) above, and its terminal skeletons can comprise an imide skeleton, an amide skeleton, a urea skeleton, a tertiary amino skeleton, an azo bond or a carboxyl group. The structural unit represented by Formula (1) includes a structural unit represented by Formulas (1-1) or (1-2) below:

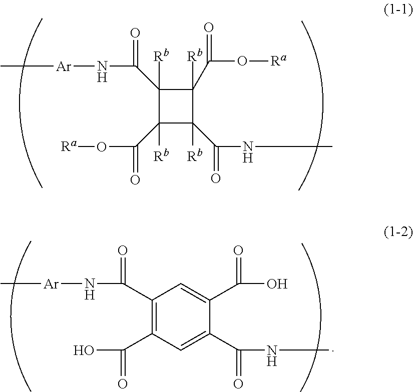

In Formulas (1-1) and (1-2), Ar is Ar⁰ or Ar¹—Z—Ar² as defined with respect to Formula (5) above. In Formula (1-1), R^{a} and R^{b} are as defined with respect to Formula (6-1) above. Z is as defined with respect to Formula (5) above.

In another embodiment, the varnish further comprises a second polyamic acid-based compound which is a polyamic acid or a polyamic acid ester, in addition to the first polyamic acid-based compound. In this case, the first polyamic acid-based compound has a polarity higher than, or a surface energy higher than, that of the second polyamic acid-based compound. Therefore, in the case where the first and second polyamic acid-based compounds are coexist in the varnish, they are phase-separated from each other. The first polyamic acid-based compound has a higher affinity for indium tin oxide (ITO) which forms pixel electrodes, inorganic passivation films such as SiO₂ or SiNₓ and organic passivation films using organic resins in a liquid crystal display device. Thus, the first polyamic acid-based compound forms a lower layer. Ordinarily, in the case where a polyamic acid ester and a polyamic acid coexist, the polyamic acid ester forms an upper layer, and the polyamic acid forms a lower layer. Further, in the case where two kinds of polyamic acid-based compounds coexist, the diamine skeleton of one of these polyamic acid-based compounds contains oxygen or fluorine, the diamine skeleton of the other polyamic acid-based compound contains neither oxygen nor fluorine or the diamine skeleton of the above other polyamic acid-based compound contains oxygen or fluorine, the amount of which is, however, less than that of the oxygen or fluorine in the diamine skeleton of the above one of the polyamic acid-based compounds, the above one of the polyamic acid-based compounds forms a lower layer, and the other polyamic acid-based compound forms an upper layer.

Needless to say, in the case where the alignment film is of a single layer, the first polyamic acid-based compound is used as the polyamic acid-based compound.

The second polyamic acid-based compound can be selected from the compounds indicated above as the first polyamic acid-based compound. Alternatively, it can be selected from polyamic acid-based compounds each of which has not yet subjected to the capping of terminal primary amino groups for the production of the first polyamic acid-based compound, i.e., from polyamic acids and polyamic acid esters, each having primary amino groups at the both terminals. However, it is preferable that the second polyamic acid-based compound, as well as the first polyamic acid-based compound, have no primary amino groups at its both terminals. Also, it is preferable that neither the first polyamic acid-based compound nor the second polyamic acid-based compound has a secondary amino group (excluding a secondary amino group forming an amide), regardless of whether the alignment film has a single-layer structure or a two-layer structure.

As is clear from the above explanation, with respect to the alignment film having a two-layer structure, a lower layer means a layer which is in direct contact with an item (for example, an ITO film, an inorganic passivation film or an organic passivation film) to which the varnish is applied, and an upper layer means a layer which is in contact with the lower layer.

In the alignment film having a two-layer structure, the first polyamic acid-based compound, which has a higher polarity, is included in the lower layer and contacts with pixel electrodes. That is, in order to suppress a DC afterimage, it is necessary to prevent accumulation of charge due to the photo-charge of the lower-layer film. Therefore, it is preferable that the first polyamic acid-based compound contained at least in the lower-layer film have no primary amino groups at its both terminals.

The varnish according to one or more embodiments described herein is applied to an item or object to be coated, and is imidized by heating at about 200° C. More specifically, in a varnish containing, as the polyamic acid-based compound, the first polyamic acid-based compound alone, the first polyamic acid-based compound is imidized. In a varnish containing, as the polyamic acid-based compounds, both the first polyamic acid-based compound and the second polyamic acid-based compound, they are phase-separated into two layers after coating, and they are both imidized by the heating.

Photo-alignment processing is carried out on the resultant imidized film, providing a photo alignment film. The photo-alignment processing can be carried out by radiating the film with a short-wavelength UV light having a wavelength of 254 or 365 nm.

In the varnish according to the embodiments described herein, as the solvent for dissolving or dispersing the polyamic acid-based compound or compounds, use may be made of N,N-dimethylformamide, N,N-dimethylacetamide, N-methyl-2-pyrrolidone, N-methylcaprolactam, 2-pyrrolidone, N-ethylpyrrolidone, N-vinylpyrrolidone, dimethyl sulfoxide, tetramehylurea, pyridine, dimethylsulfone, hexamethyl sulfoxide, γ-butyrolactone, 1,3-dimethyl-imidazolidinone, ethyl amyl ketone, methyl nonyl ketone, methyl ethyl ketone, methyl isoamyl ketone, methyl isopropyl ketone, cyclohexanone, ethylene carbonate, propylene carbonate, diglyme and 4-hydroxy-4-methyl-2-pentanone.

According to a second aspect, there is provided a liquid crystal display device comprising the imidized photo alignment film noted above.

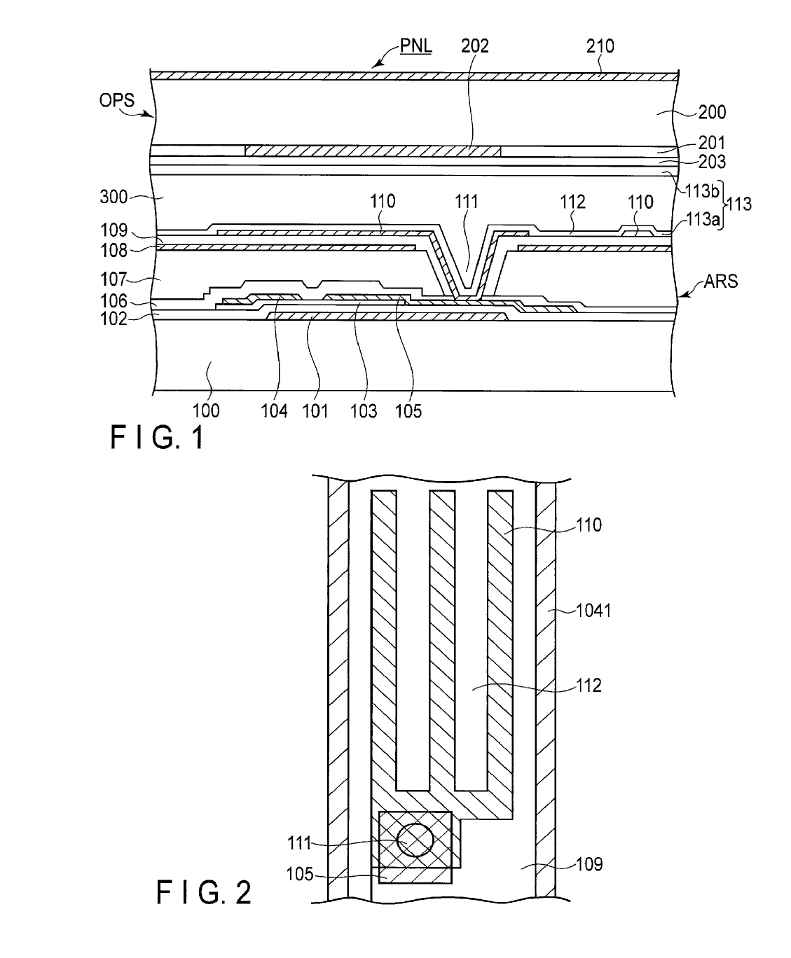

FIG. 1 is a cross-sectional view partially illustrating a display panel PNL of a lateral electric field type liquid crystal display device.

Referring to FIG. 1, the display panel PLN includes an array substrate ARS and an opposite substrate OPS disposed opposite to, and spaced apart from, the array substrate ARS. A liquid crystal layer 300 is provided between the array substrate ARS and the opposite substrate OPS.

The array substrate ARS includes a first glass substrate 100. A gate electrode 101 is provided on the first glass substrate 100. The gate electrode 101 has the same thickness as each of scanning lines (not shown) provided on the first glass substrate 100. The gate electrode 101 can have a two-layer structure, with a lower layer, which is in direct contact with the first glass substrate 100, being formed of, for example, an AlNd alloy, and an upper layer being formed of, for example, a MoCr alloy.

A gate insulating film 102 is provided, covering the gate electrode 101. The gate insulating film 102 is formed of, for example, SiN. On the gate insulating film 102, a semiconductor layer 103 is provided at a location opposite to the gate electrode 101. The semiconductor layer 103 is formed of, for example, amorphous silicon (a-Si film). The semiconductor layer 103 forms the channel portion of a TFT (not shown). On the semiconductor layer 103, a drain electrode 104 and a source electrode 105 are provided through the above channel portion. Between the semiconductor layer 103 and the drain electrode 104 or the source electrode 105, an n⁺-Si layer (not shown) is provided in order to establish an ohmic contact between them.

An image signal line doubles as the drain electrode 104, and the source electrode 105 is connected to a pixel electrode 110. The drain electrode 104 and the source electrode 105 are formed of, for example, a MoCr alloy.

An inorganic passivation film 106 is provided, covering the TFT. The inorganic passivation film 106 is formed of, for example, SiN. The inorganic passivation film 106 protects the TFT, especially, the channel portion thereof, from impurities. An organic passivation film 107 is provided on the inorganic passivation film 106. The organic passivation film 107 serves to protect the TFT, and also to planarize the surfaces. Therefore, the organic passivation film 107 is formed to be thick, for example, in a thickness of 1 to 4 μm. The organic passivation film is formed of, for example, “OPTMER PC Series” available from JSR Corporation.

A counter-electrode 108 is provided on the organic passivation film 107. The counter-electrode 108 is formed of a transparent electrically conductive material, for example, ITO. The counter-electrode 108 is formed planarly over the entire display area.

An interlayer insulating film 109 is provided, covering the counter-electrode 108. The interlayer insulating film 109 is formed of, for example, SiN.

A through hole 111 is provided, penetrating the interlayer insulating film 109, the counter-electrode 108, the organic passivation film 107 and the inorganic passivation film to partially expose the surface of the source electrode 105.

The pixel electrode 110 is provided, covering the interlayer insulating film 109, and also covering the inner side surface and the bottom surface of the through hole 111. The pixel electrode 110 is formed of, for example, ITO. The pixel electrode 110 is connected to the portion of the source electrode 105 which is exposed by the through hole 111. Thus, in the through hole 111, the pixel electrode 110 and the source electrode 105, which extends from the TFT, are electrically connected to each other, and an image signal is supplied to the pixel electrode 110.

FIG. 2 partially illustrates an example of the pixel electrode 110. The pixel electrode 110 is a comb-tooth electrode. On both sides of the pixel electrode 110, image signal lines 1041 are provided. Slits 112 are provided between the comb-teeth of the pixel electrode 110. Also, the planar counter-electrode 108 is provided below the pixel electrode 110. When an image signal is supplied to the pixel electrode 110, liquid crystal molecules are rotated by an electric flux produced between the pixel electrode 110 and the counter-electrode 108 through the slits 112. Accordingly, light passing through the liquid crystal layer 300 is controlled to form an image.

Referring back to FIG. 1, an alignment film 113a which aligns liquid crystal molecules is provided on the pixel electrode 110. The construction of the alignment film 113a will be described later.

The opposite substrate OPS comprises a second glass substrate 200. Color filers 201 including red, green and blue filter segments are provided on the inner surface of the second glass substrate 200. Between the color filters 201, a black matrix 202 is formed, and improves the contrast of the image. The black matrix 202 also serves as a light-shielding film for the TFT, and prevents photocurrent from flowing into the TFT.

An overcoat film 203 is formed, covering the color filters 201 and the black matrix 202. The overcoat film 203 planarizes the surfaces of the color filters 201 and the black matrix 202.

An alignment film 113b is provided on the overcoat film 203 to cause, together with the alignment film 113a, the liquid crystals to be aligned in an initial alignment state. The construction of the alignment film 113b will be described later.

An external electrically conductive film 210 is formed on an outer surface of the second glass substrate 200 to stabilize the potential inside the liquid crystal display panel PNL. A predetermined voltage is applied to the external electrically conductive film 210.

In one embodiment, each of the alignment films 113a and 113b is a single layer film, and comprises the imidized product of the first polyamic acid-based compound. In another embodiment, each of the alignment films 113a and 113b is of a two-layer structure provided with a film comprising the imidized product of the first polyamic acid-based compound and a film comprising the imidized product of the second polyamic acid-based compound. In still another embodiment, one of the alignment films 113a and 113b is a single layer film which comprises the imidized product of the first polyamic acid-based compound, while the other alignment film is of a two-layer structure provided with a film comprising the imidized product of the first polyamic acid-based compound as the lower layer and a film comprising the imidized product of the second polyamic acid-based compound as the upper layer. The alignment films 113a and 113b will be collectively denoted as alignment film 113 hereinafter.

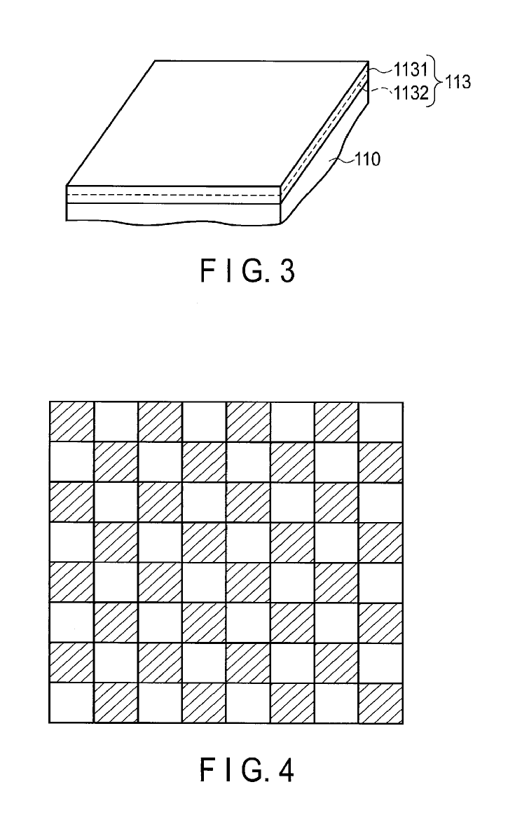

FIG. 3 is a schematic view illustrating the alignment film 113 having a two-layer structure according to one embodiment. In the Figure, the alignment film 113 is formed on the pixel electrode 110. The alignment film 113 is provided with an upper film 1131 and a lower film 1132. It should be noted that the boundary between the upper film 1131 and the lower film 1132 of the alignment film 113 is not clear, so the boundary is indicated by a dotted line in FIG. 3.

It is preferable that the lower layer in the alignment film having a two-layer structure occupy 30% by weight or more but 60% by weight or less of the total amount of the two-layer alignment film.

Further, it is preferable that the drive frequency (the number of times the image signal is supplied to the pixel electrodes per frame) of the liquid crystal display device fall within the range of 40 Hz or less, preferably 1 Hz or more, which leads to reduction in the power consumption. Furthermore, in the case of a low frequency driving, it is preferable that the resistance of the alignment film be high in order to suppress the lowering of the brightness during the voltage is held by the pixel electrode. The volume resistivity of the alignment film is preferably 5×10¹³ Ωcm or more, more preferably 1×10¹⁶ Ωcm or less, most preferably 5×10¹⁵ Ωcm or less.

Some Examples will be described below, but firstly Synthetic Examples of polyamic acid-based compounds will be described.

### Synthetic Example 1

A solution of 100 parts by mol of 2,4-dimethyl-1,2,3,4-cyclobutanetetracarboxylic dianhydride in N-methyl-2-pyrrolidone (NMP) and a solution of 110 parts by mol of p-phenylenediamine in NMP were mixed together, and the mixture was reacted at room temperature for 8 hours, producing a polyamic acid having primary amines at its both terminals. To the reaction mixture, 100 parts by mol of N,N-dimethylformamide dimethyl acetal were added dropwise, and the mixture was reacted at 50° C. for 2 hours, methyl-esterifying the two carboxyl groups in each acid skeleton. To the resulting reaction mixture, a solution of 5 parts by mol of phthalic anhydride in NMP was added, and the mixture was reacted at room temperature for 8 hours, capping the primary amino groups at the both terminals of the polyamic acid into amic acids. The unreacted monomers and low-molecular-weight components were removed, giving a solution of a desired polyamic acid ester having both terminals capped and a solids concentration of 15% by weight.

### Synthetic Example 2

A solution of 100 parts by mol of 1,2,3,4-cyclobutanetetracarboxylic dianhydride in NMP and a solution of 110 parts by mol of 4,4′-diaminodiphenyl ether in NMP were mixed together, and the mixture was reacted at room temperature for 8 hours, producing a polyamic acid having primary amines at its both terminals. To the reaction mixture, a solution of 5 parts by mol of phthalic anhydride in NMP was added, and reacted at room temperature for 8 hours, capping the primary amino groups at both terminals of the polyamic acid into amic acids. The unreacted monomers and low-molecular-weight components were removed, giving a polyamic acid solution having a solids concentration of 15% by weight.

### Synthetic Example 3

A solution of 100 parts by mol of 1,2,3,4-cyclobutanetetracarboxylic dianhydride in NMP and a solution of 110 parts by mol of paraphenylenediamine in NMP were mixed together, and the mixture was reacted at room temperature for 8 hours, producing a polyamic acid having primary amines at its both terminals. To this reaction mixture, a solution of 5 parts by mol of benzoyl chloride in NMP was added, and the mixture was reacted at room temperature for 8 hours, capping the primary amino groups at both terminals of the polyamic acid (amidation). The unreacted monomers and low-molecular-weight components were removed, giving a polyamic acid solution having a solids concentration of 15% by weight.

### Synthetic Example 4

The same procedures were taken as in Synthetic Example 2 except that benzoyl chloride was used instead of phthalic anhydride, giving a solution of a polyamic acid having the primary amino groups at both terminals amidated.

### Synthetic Example 5

A solution of 100 parts by mol of 1,2,3,4-cyclobutanetetracarboxylic dianhydride in NMP and a solution of 90 parts by mol of 4,4′-diaminodiphenyl ether in NMP were mixed together, and the mixture was reacted with at room temperature for 8 hours, producing a polyamic acid having carboxyl groups at its both terminals. The unreacted monomers and low-molecular-weight components were removed, giving a polyamic acid solution having a solids concentration of 15% by weight.

### Synthetic Example 6

A solution of 100 parts by mol of 2,4-dimethyl-1,2,3,4-cyclobutanetetracarboxylic dianhydride in NMP and a solution of 110 parts by mol of paraphenylenediamine in NMP were mixed together, and the mixture was reacted at room temperature for 8 hours, producing a polyamic acid having primary amines at its both terminals. To this reaction mixture, 100 parts by mol of N, N-dimethylformamide dimethyl acetal were added dropwise, and the mixture was reacted at 50° C. for 2 hours, thereby methyl-esterifying the two carboxyl groups in each acid skeleton. The unreacted monomers and low-molecular-weight components were removed, giving a solution of a desired polyamic acid ester having primary amino groups at both terminals and a solids concentration of 15% by weight.

### Synthetic Example 7

A solution of 100 parts by mol of pyromellitic dianhydride in NMP and a solution of 110 parts by mol of 4,4′-paradiaminodiphenyl ether in NMP were mixed together, and the mixture was reacted at room temperature for 8 hours, producing a polyamic acid having primary amines at its both terminals. To this reaction mixture, a solution of 5 parts by mol of phthalic anhydride in NMP was added, and the mixture was reacted at room temperature for 8 hours, thereby capping the primary amino groups at both terminals of the polyamic acid into amic acids. The unreacted monomers and low-molecular-weight components were removed, giving a polyamic acid solution having a solids concentration of 15% by weight.

### Synthetic Example 8

The same procedures were taken as in Synthetic Example 3, except that phthalic anhydride was used instead of benzoyl chloride, producing a solution of a desired polyamic acid having its both terminals capped with amides.

### Synthetic Example 9

A solution of 100 parts by mol of 1,2,3,4-cyclobutanetetracarboxylic dianhydride in NMP and a solution of 110 parts by mol of paraphenylenediamine in NMP were mixed together, and the mixture was reacted at room temperature for 8 hours, producing a polyamic acid having primary amines at its both terminals. The unreacted monomers and low-molecular-weight components were removed, gibing a polyamic acid solution having a solids concentration of 15% by weight.

### Synthetic Example 10

A solution of 100 parts by mol of 1,2,3,4-cyclobutanetetracarboxylic dianhydride in NMP and a solution of 110 parts by mol of 4,4′-paradiaminodiphenyl ether in NMP were mixed together, and the mixture was reacted at room temperature for 8 hours, producing a polyamic acid having primary amines at its both terminals. The unreacted monomers and low-molecular-weight components were removed, giving a polyamic acid solution having a solids concentration of 15% by weight.

The acid skeletons, diamine skeletons and terminal skeletons of the polyamic acid-based compounds produced in Synthetic Examples 1 to 10 noted above are shown in Table 1 below. In Table 1, the mark “*” added to an acid skeleton represents a binding site to the amine skeleton, and the mark “*” added to an amine skeleton represents a binding site to the acid skeleton. The mark “*” added to the terminal skeleton represents a binding site to the acid skeleton if the terminal skeletons have amides, imides or primary amino groups, and represents a binding site to the amine skeleton if the terminal skeletons have carboxyl groups.

TABLE 1

| Synthesis | | |
|---|---|---|
| Example | Acid skeleton | Diamine skeleton |
| 1 | 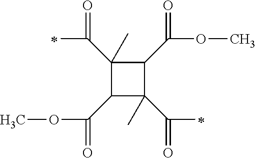 | 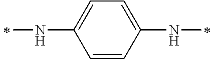 |
| 2 | 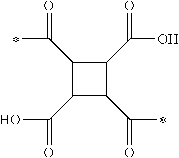 | 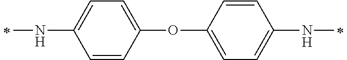 |
| 3 | 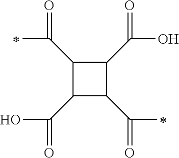 | 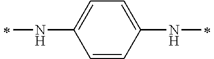 |
| 4 | 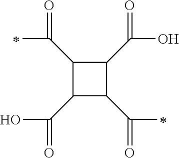 | 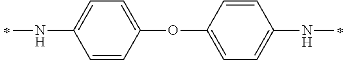 |
| 5 | 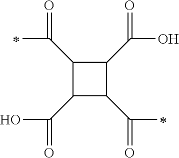 | 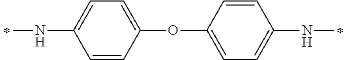 |
| 6 | 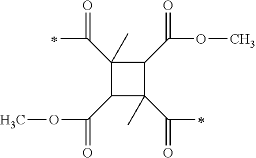 | 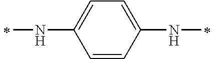 |
| 7 | 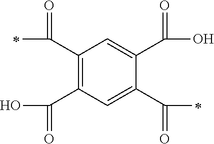 | 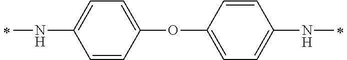 |
| 8 | 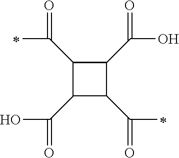 | 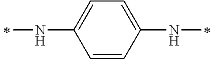 |
| 9 | 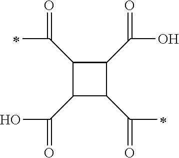 | 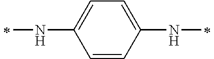 |
| 10 | 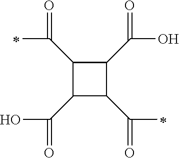 | 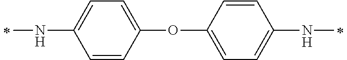 |

| Synthesis | |
|---|---|
| Example | Each terminal skeleton |
| 1 | 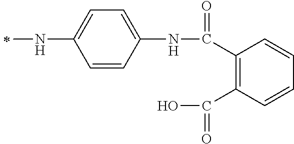 |
| 2 | 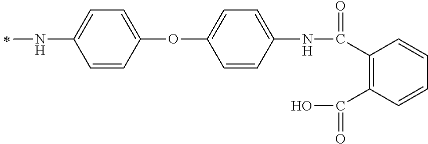 |
| 3 | 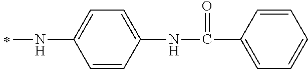 |
| 4 | 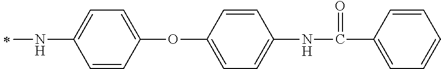 |
| 5 | 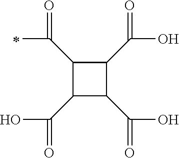 |
| 6 | 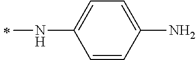 |
| 7 | 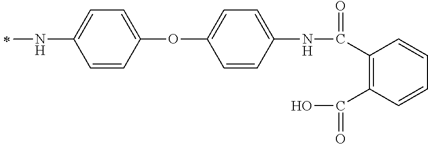 |
| 8 | 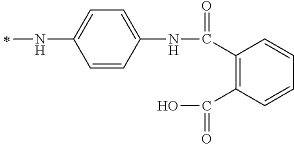 |
| 9 | 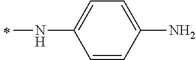 |
| 10 | 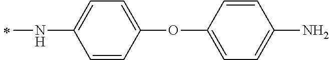 |

### Examples 1 to 5 and Comparative Example

Coating liquids were prepared by mixing the upper-layer components and lower-layer components indicated in Table 2 at the weight ratio of 1:1 (the coating liquid of Example 5 is the polyamic acid solution alone of Synthetic Example 8). In the liquid crystal display device having the structure as illustrated in FIG. 1, the coating liquids were applied to the areas of the array substrate and the opposite substrate, which were to be coated with alignment films 113, and were imidized by heating at 200° C. The imidization degree in all the Examples was 80%. Photo-alignment processing was conducted on each of the resultant imidized films using short wavelength UV light. The liquid crystal display devices provided with the display panels having the structure as illustrated in FIG. 1 were fabricated, using array substrates and opposite substrates provided with alignment films thus formed. A nematic liquid crystal material (MLC-2039 available from Merk & Co., Inc.) having negative dielectric anisotropy Ar the value of which was −4.1 (1 kHz, 20° C.) and refractive anisotropy Δn the value of which was 0.0821 (wavelength of 590 nm, 20° C.) was used as the liquid crystal.

It should be noted that the polyamic acid-based compounds of Synthetic Examples 1 and 8 and Synthetic Examples 2 and 7, including the terminals, were imidized. That is, the terminal skeletons of the photo alignment films were imide-capped as indicated below.

### Synthetic Examples 1 and 8 (Imidized Terminal Skeleton)

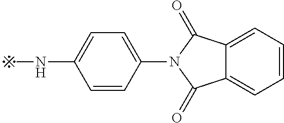

### Synthetic Examples 2 and 7 (Imidized Terminal Skeleton)

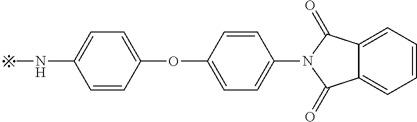

The fabricated liquid crystal display devices were operated to display a white and black (shaded) checkered flag pattern as illustrated in FIG. 4 for 100 hours. Each of checkers forming the checkered flag pattern was a square having four sides of equal length of 5 mm. White is the maximum luminance (256th level of 256 levels of gray), and black is the minimum luminance (0th level of 256 levels of gray). Then, when the liquid crystal display devices were each operated to display gray at the 31st level of 256 levels of gray on the entire screen of each liquid crystal display device, it was observed that the areas corresponding to the white checkers which had displayed white for 100 hours exhibited luminance different from that of the areas corresponding to the black checkers which had displayed black for 100 hours. The change rate of the luminance of the both areas noted above is calculated by the following formula:

{(a−b)/b}×100

where a is the luminance of the areas corresponding to the white checkers which had displayed white for 100 hours, and b is the luminance of the areas corresponding to the black checkers which had displayed black for 100 hours. The change rate is defined as the intensity of afterimage. If a numeral value obtained by the above formula is greater than or equal to 1%, afterimage is recognized by human's eyes.

The change of the afterimage intensity over time was measured when the gray was displayed after the checkered flag pattern was continuously displayed for 100 hours, and was evaluated on a scale of A to C below.

A: No afterimage generated from the initial stage

B: A visible afterimage generated at the initial stage of the gray-displaying operation, and disappeared within one hour.

C: A visible afterimage generated at the initial stage of the gray-displaying operation, and did not disappear even after one hour.

The results are shown also in Table 2. It should be noted that Table 2 also simply indicates both terminal skeletons of the polyamic acid-based compounds prepared in the Synthetic Examples.

TABLE 2

| | | Polyamic acid-based | Terminal | DC after- |
|---|---|---|---|---|
| | | compound | skeleton | image |
| Ex. 1 | Upper layer | Synthetic Ex. 1 | Imide | A |
| | component | | | |
| | Lower layer | Synthetic Ex. 2 | Imide | |
| | component | | | |
| Ex. 2 | Upper layer | Synthetic Ex. 3 | Amide | A |
| | component | | | |
| | Lower layer | Synthetic Ex. 4 | Amide | |
| | component | | | |
| Ex. 3 | Upper layer | Synthetic Ex. 1 | Imide | A |
| | component | | | |
| | Lower layer | Synthetic Ex. 5 | Carboxylic | |
| | component | | acid | |
| Ex. 4 | Upper layer | Synthetic Ex. 6 | Primary | B |
| | component | | amine | |
| | Lower layer | Synthetic Ex. 7 | Imide | |
| | component | | | |
| Ex. 5 | Single layer | Synthetic Ex. 8 | Imide | A |
| Comp. | Upper layer | Synthetic Ex. 9 | Primary | C |
| Ex. | component | | amine | |
| | Lower layer | Synthetic Ex. 10 | Primary | |
| | component | | amine | |

As described in detail above, according to one or more embodiments described above, a varnish for producing photo alignment films is provided, which does not cause a DC afterimage or causes an DC afterimage to disappear in a short period of time even if the DC afterimage is generated, and also a liquid crystal display device is provided, in which a DC afterimage is not generated or disappears within a short period of time even if the afterimage is generated.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A varnish for a photo alignment film comprising a first polyamic acid-based compound, which is a polyamic acid or a polyamic acid ester, in an organic solvent, wherein the first polyamic acid-based compound has terminal skeletons containing no primary amino group.

2. The varnish according to claim 1, wherein the terminal skeleton comprises an imide skeleton, an amide skeleton, a urea skeleton, a tertiary amino skeleton, an azo bond or carboxyl group.

3. The varnish according to claim 1, wherein the first polyamic acid-based compound has a structural unit represented by Formula (1) below: 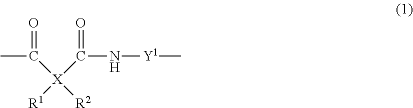
where X is a cyclic group, each of R¹ and R² is independently —COOH or —COOR where R is an alkyl group, and Y¹ is an organic group, and
the terminal skeleton comprises an imide skeleton, an amide skeleton, a urea skeleton, a tertiary amino skeleton, an azo bond or carboxyl group.

4. The varnish according to claim 3, wherein the terminal skeleton comprises an amic acid skeleton or an amic acid ester skeleton.

5. The varnish according to claim 3, wherein the terminal skeleton is represented by
Formula (2) below: 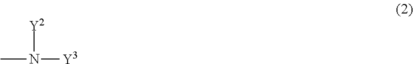
where Y² is H, S or an organic group, and Y³ is an aliphatic group or an aromatic group; or Y² and Y³ are bonded together to form a cyclic group;
Formula (3) below:
—N═N—Y⁴ (3)
where Y⁴ is an organic group; or
Formula (4) below: 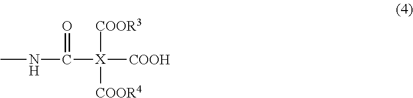
where each of R³ and R⁴ is independently an alkyl group.

6. The varnish according to claim 3, wherein X is an alicyclic group.

7. The varnish according to claim 4, wherein X is an alicyclic group.

8. The varnish according to claim 5, wherein X is an alicyclic group.

9. The varnish according to claim 1, wherein the first polyamic acid-based compound has a diamine skeleton represented by Formula (5) below:
—HN-L-NH— (5)
where L is Ar⁰, or Ar¹—Z—Ar², each of Ar⁰, Ar¹ and Ar² is independently an organic group, and Z is an organic group containing no primary and secondary amino groups.

10. The varnish according to claim 3, wherein the first polyamic acid-based compound has a diamine skeleton represented by Formula (5):
—HN-L-NH— (5)
where L is Ar⁰, or Ar¹—Z—Ar², each of Ar⁰, Ar¹ and Ar² is independently an organic group, and Z is an organic group containing no primary and secondary amino groups.

11. The varnish according to claim 5, wherein the first polyamic acid-based compound has a diamine skeleton represented by Formula (5):
—HN-L-NH— (5)
where L is Ar⁰, or Ar¹—Z—Ar², each of Ar⁰, Ar¹ and Ar² is independently an organic group, and Z is an organic group containing no primary and secondary amino groups.

12. The varnish according to claim 9, wherein Z is constituted by oxygen, nitrogen, sulfur, carbon, hydrogen, or a combination of two or more of them, and Z has no hydroxyl group, no thiol group and no amino group, —NH or >NH, other than a tertiary amino group.

13. The varnish according to claim 10, wherein Z is constituted by oxygen, nitrogen, sulfur, carbon, hydrogen, or a combination of two or more of them, and Z does no hydroxyl group, no thiol group and no amino group, —NH or >NH, other than a tertiary amino group.

14. The varnish according to claim 11, wherein Z is constituted by oxygen, nitrogen, sulfur, carbon, hydrogen, or a combination of two or more of them, and Z has no hydroxyl group, no thiol group and no amino group, —NH or >NH, other than a tertiary amino group.

15. The varnish according to claim 1, further comprising a second polyamic acid-based compound, which is a polyamic acid or a polyamic acid ester, and the first polyamic acid-based compound has a polarity higher than that of the second polyamic acid-based compound.

16. The varnish according to claim 15, wherein the second polyamic acid-based compound has terminal skeletons containing no primary amino group.

17. A liquid crystal display device comprising an alignment film comprising an imidized product of the varnish according to claim 1.

18. A liquid crystal display device comprising an alignment film comprising an imidized product of the varnish according to claim 15.
